(19) United States
(12) Patent Application Publication
(10) Pub. No.: US 2013/0246136 A1
(43) Pub. Date: Sep. 19, 2013

(54) Device, System and Method For Facilitating Interaction Between A Wireless Communcation Device and a Package

(71) Applicant: CROWN PACKAGING TECHNOLOGY, INC., Alsip, IL (US)

(72) Inventors: Christopher Paul Ramsey, Wantage (GB); Laura Jane Vaughan, Eglinton (GB)

(73) Assignee: CROWN PACKAGING TECHNOLOGY, INC., Alsip, IL (US)

(21) Appl. No.: 13/827,003

(22) Filed: Mar. 14, 2013

Related U.S. Application Data
(60) Provisional application No. 61/612,064, filed on Mar. 16, 2012.
(60) Provisional application No. 61/611,222, filed on Mar. 15, 2012.

(51) Int. Cl. G06Q 30/06; A63F 13/00; B65D 85/00

(52) U.S. Cl. CPC G06Q 30/0643; A63F 13/00; B65D 85/00
USPC 705/14.12; 463/29; 29/592; 206/459.1; 705/27.1; 705/26.7; 705/306; 235/375

(57) ABSTRACT

A method of providing a personalized experience on a wireless communication device corresponding to the contents of a package, the package containing a product may include the steps of reading a unique code on a package, the package containing a product, displaying a personalized illusory images on the wireless communication device, and altering the personalized illusory images in response to relative movement between the package and the camera.

### CROSS REFERENCE TO RELATED APPLICATIONS

This application claims benefit under 35 U.S.C. §119(e) of Provisional U.S. Patent Application No. 61/612,064, filed Mar. 16, 2012, and Provisional U.S. Patent Application No. 61/611,222, filed Mar. 15, 2012, the contents of which are incorporated herein by reference in their entirety.

### BACKGROUND

Embodiments of the devices, systems, and methods described herein relate to methods and systems to facilitate and enable interaction between a computing device, such as a wireless communication device and a package, such as a metal package.

Metal packaging can be divided into disposable packages and durable packages. Disposable metal packages, such as food and beverage cans, are intended to be disposed of and recycled very soon after opening. In fact, it is beneficial to recycle disposable cans for environmental reasons.

Durable metal packages, such as those formed and decorated tinplate boxes for premium liquors, candy, and the like, on the other hand, are often reused. Durable metal packages also are often distinguished from disposable metal packages in that durable metal packages often have a lid that is reclosable, while disposable metal packages often have a panel that is ruptured by a score or can opener.

### SUMMARY

According to one embodiment, a method of providing a personalized experience on a wireless communication device corresponding to the contents of a package is provided. The package containing a product may include the steps of reading a unique code on a package, the package containing a product, displaying a personalized illusory image on the wireless communication device, and altering the personalized illusory images in response to relative movement between the package and the camera.

In another embodiment, a method is provided of having a gaming interaction between a package and a wireless communication device. The package having a unique code may include the steps of reading the unique code, in response to the reading step, displaying game images, and modifying the game images in response to physical movement of the package relative to the wireless communication device, the physical movement determining an outcome of the gaming interaction.

In another embodiment, a system is configured to facilitate a gaming interaction using a wireless communication device may include a package. The package including a unique code. The system further includes an application configured to run on the wireless communication device in response to the wireless communication device reading the unique code, the application further being configured to display game images and modify the game images in response to physical movement of the package relative to the wireless communication device, the physical movement determining an outcome of the gaming interaction.

In another embodiment, a method for registering credits based on voucher information on a wireless communication device may include the steps of reading a unique code, the code being marked on a package, and in response to the reading step, incorporating the new purchase voucher information to pre-existing voucher information.

In another embodiment, a system configured to register credits based on voucher information on a wireless communication device may include a package that includes a unique code. The system further includes an application configured to run on the wireless communication device in response to the wireless communication device reading the unique code, the application further being configured to incorporate the new purchase voucher information with pre-existing voucher information.

In another embodiment, a method of displaying repurchase options on a wireless communication device may include the steps of reading a unique code, the unique code being on a package that contains a product, identifying a geographic location of the wireless communication device using GPS, and displaying information about repurchase options of the product that corresponds to the geographic location.

In another embodiment, a system is configured to display repurchase options on a wireless communication device and may include a package, the package including a unique code. The system may further include an application configured to run on the wireless communication device in response to the wireless communication device reading the unique code, the application further being configured to read a unique code, the unique code being on a package that contains a product identify a geographic location of the wireless communication device using GPS, and display information about repurchase options of the product that corresponds to the geographic location.

In another embodiment, a method of receiving a gift message associated with a package having a unique code on a wireless communication device may include the steps of reading the unique code, and displaying an image that corresponds to the gift message, the gift message being a pre-inputted message provided by a gift giver.

In another embodiment, a system is configured to display a gift message on a wireless communication device and may include a package, the package including a unique code. The system may further include an application configured to run on the wireless communication device in response to the wireless communication device reading the unique code, the application further being configured to identify a geographic location of the wireless communication device using GPS and display information about repurchase options of the product.

In another embodiment, a method of validating a product's authenticity using a wireless communication device may include the steps of reading a unique code on a package that contains the product, in response to the reading step, identifying a geographic location of the wireless communication device using GPS, comparing the geographic location with a list of authorized sellers of the product, and determining the authenticity of the product based on the comparing step.

In another embodiment, a system is configured to validate a product's authenticity using a wireless communication device and may include a package, the package including a unique code. The system may further include an application configured to run on the wireless communication device in response to the wireless communication device reading the unique code, the application further being configured to identify a geographic location of the wireless communication device using GPS, compare the geographic location with a list of authorized sellers of the product, and determine the authenticity of the product based on the comparing step.

In another embodiment, a package is configured to provide quality information and may include a container, the container including a changeable marking that is configured to display a unique code in response to at least one environmental condition of the container and a product enclosed within the container, wherein the change in response to the at least one environmental condition reflects a change to the at least one environmental condition of the product, and the at least one environmental condition includes at least one of a temperature range, a time-temperature condition, and light of a particular wavelength.

In another embodiment, a stocking system may be configured to manage stock and includes a shelf and a smart surface disposed on the shelf. The smart surface may be configured to read unique codes on packages and to transfer and receive information about the packages so as to facilitate determining remaining shelf life of the packages, determining need for restocking of shelf, and alerting of a potential issue relating to the packages.

In another embodiment, a method of manufacturing a packaged product may include the steps of introducing a product into a package, the package including a marking, closing the package, processing the package according to a predetermined process, wherein the processing step changes the marking to display a unique code so as to indicate whether a predetermined time-temperature condition was satisfied during the processing step, and determining whether the predetermined time-temperature condition was satisfied during the processing step.

In another embodiment, a method of manufacturing a container may include the steps of positioning the container, filling the container with a product, and marking the container with a unique code.

### BRIEF DESCRIPTION OF THE DRAWINGS

The foregoing summary, as well as the following detailed description of the various embodiments of the application, will be better understood when read in conjunction with the appended drawings. For the purposes of illustrating the various embodiments of the disclosure, reference is made to the drawings. It should be understood, however, that the application is not limited to the precise arrangements and instrumentalities illustrated in the drawings, in which:

FIG. 1 is a schematic of a method for facilitating interaction between a wireless communication device and a package having a readable code;

FIG. 2 is a schematic of an exemplary embodiment of a system for facilitating interaction between a wireless communication device and a package having a readable code;

FIGS. 3A-G show different types of codes which may be applied as markings to packages and components of packages;

FIG. 4 shows a QR code applied to the underside of a lid of a hinged metal container;

FIGS. 5A-D show different types of codes applied to the undersides of tabs of metal beverage cans;

FIGS. 6A and 6B show codes applied to the topsides of tabs of a metal beverage cans;

FIG. 6C shows multiple codes applied to the topside of a metal beverage can, wherein each of the codes is at least partially obscured by the tab;

FIG. 7A shows a QR code applied to the bottom external surface of a metal beverage can;

FIG. 7B shows a QR code applied to the internal upper surface of a base of a metal beverage can with a full aperture opening;

FIG. 7C shows a QR code applied to the underside surface of a removable portion of a metal beverage can with a full aperture opening;

FIGS. 8A-C show QR codes applied to the upper surfaces of metal food cans;

FIG. 9A shows a QR code applied to a removable portion of a metal food can;

FIG. 9B shows a QR code applied to the outside surface of the cylindrical portion of a food can body;

FIG. 9C shows a QR code applied to an internal upper surface of a base of a metal food can;

FIG. 10A shows a QR code applied to the external surface of a metal lid, such as a metal lid for a glass container;

FIG. 10B shows a QR code applied to the internal surface of a metal lid, such as a metal lid for a glass container;

FIG. 11 shows a QR code applied to an internal surface of a metal end cap, such as a metal end cap for a tubular cardboard package;

FIG. 12A shows a QR code applied to an external surface of a metal crown cap;

FIGS. 12B and 12C show QR codes applied to internal surfaces of metal crown caps;

FIG. 13 is a block diagram of an example computing device for use in accordance with the present disclosure;

FIG. 14 is an example communication architecture for use in accordance with the present disclosure;

FIGS. 15A-D show exemplary gaming interactions;

FIGS. 16A-D show exemplary promotional interactions;

FIG. 17 shows an exemplary repurchase interaction;

FIGS. 18A and 18B show exemplary gift message interactions;

FIG. 19 shows an exemplary validating interaction; and

FIG. 20 shows an exemplary stocking system.

### DETAILED DESCRIPTION OF ILLUSTRATIVE EMBODIMENTS

The various aspects of the subject matter described herein are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

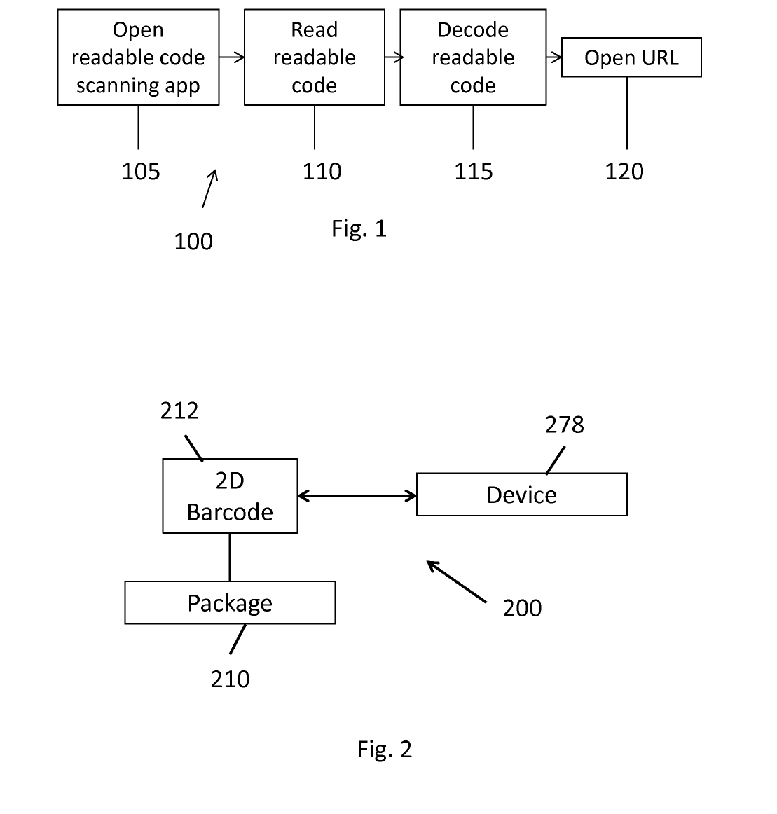

With reference to FIGS. 1 and 2, a method 100 and system 200 for facilitating interaction between a communication device 278 and a package 210 having a readable code 212 are provided. In some embodiments, more than one readable code may be used so that readable codes 212 are in multiple locations on the container 211. Alternatively, only one code may be required on the metal container. The readable code 212 preferably is a QR code, although any other suitable codes may be used. For example, a UPC symbol or a High Capacity Color Barcode, such as a Microsoft tag, may be employed. Alternatively, a data matrix tag may be used.

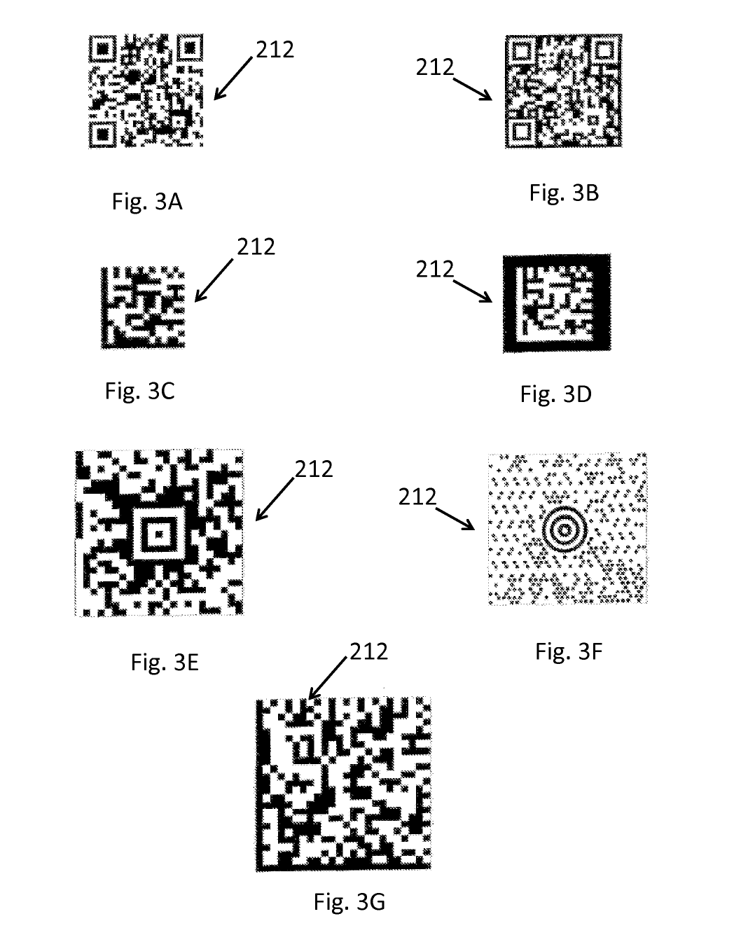

Examples of readable codes 212 are shown in FIGS. 3A-G. For example, FIG. 3A shows a QR code which may be scanned by the computing device 278. FIG. 3B shows an inverted QR code, which may be scanned in a similar way. Determining whether to use a QR code or an inverted QR code typically depends on the selection of inks, lacquers and other pigmented materials being applied to the package 210 as described in more detail below. FIG. 3C shows a data matrix, whilst FIG. 3D shows an inverted data matrix. Other types of readable code 212 include an Aztec code as shown in FIG. 3E, a maxicode as shown in FIG. 3F, and a semacode as shown in FIG. 3G.

Readable code 212 preferably is a unique code. Specifically, readable code 212 may be unique to a package or a group of packages 210. For example, for a given group of 100 otherwise identical packages 210, each package may have a distinct code, so that there are 100 codes. Alternatively, all 100 otherwise identical packages 210 may have the same code, so that there is one code. Alternatively, there may be multiple groups of packages 210, such that the number of codes within the group is between 1 and 100. In some embodiments, one of more of the containers 211 in the group may not have a readable code 212.

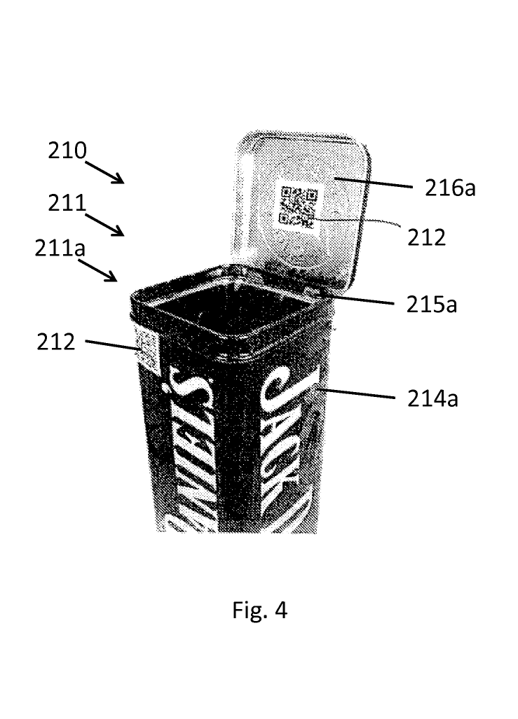

Package 210 also includes a product (not shown) enclosed in the container 211. The product may be anything suitable for enclosure in the container 211. Container 211 may be a metal container 211a, such as a rigid metal container shown in FIG. 4. Metal container 211a may be formed of decorated sheet steel or aluminum and includes a body 214a and a lid 216a. The lid 216a may be attached to the body 214a by a hinge 215a. Readable code 212 may be located in multiple places on the container 211a. For example, as shown in FIG. 4, the readable code 212 may be on the underside of the lid 216a. The readable code 212 may also be on an outside surface of the body 214a. Alternatively, the readable code 212 may be on the topside of the lid 216a, or may be on an inside surface on the body 214a. Containers such as metal container 211a, with hinged lids, may be used to package various products such as breath mints, premium liquor, premium or seasonal candies, and the like.

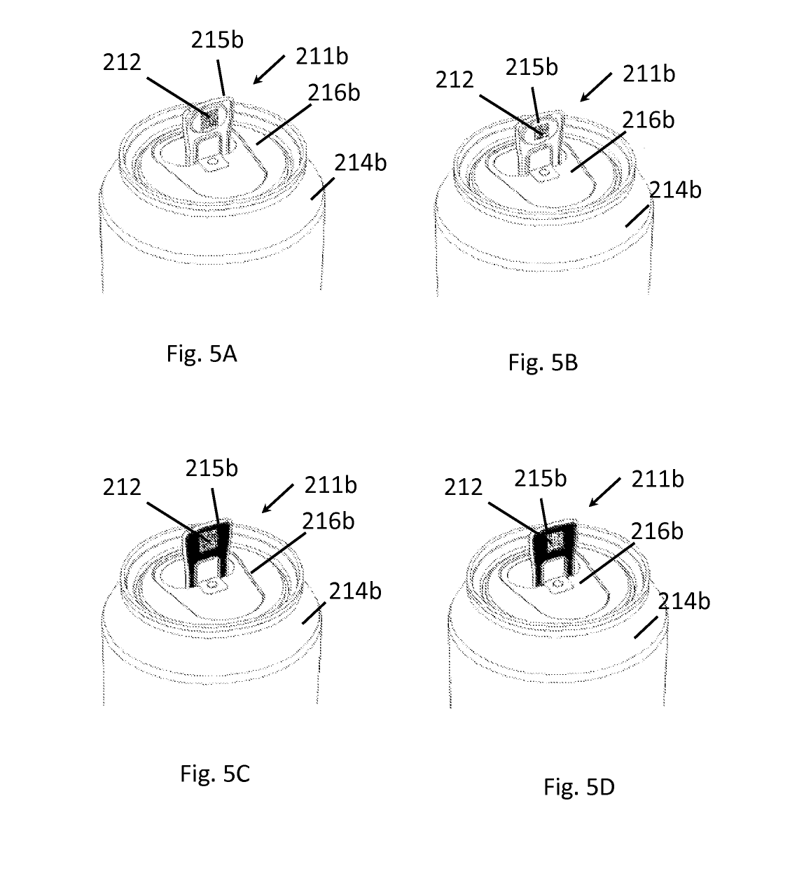

Referring to FIGS. 5A-D, a metal beverage container 211b includes a body 214b, an end 216b, and a tab 215b riveted to the end 216b. Readable code 212 may be hidden on an underside of the tab 215b such that it is configured to be revealed when the tab is lifted to open the metal beverage container 211b. FIG. 5A shows a QR code printed on the underside of the tab 215b. FIG. 5B shows a data matrix printed on the underside of the tab 215b. FIG. 5C shows an inverted QR code printed on the underside of the tab 215b. FIG. 5D shows an inverted data matrix printed on the underside of the tab 215b. Tab 215b may be manufactured separately from the other components of the metal beverage container 211b and then attached to the end 216b before the end 216b is seemed to the body 214b. Accordingly, the readable code 212 may be applied to the tab 215b separately from decoration applied to the end 216b or body 214b, before the tab 215b is riveted to the end 216b

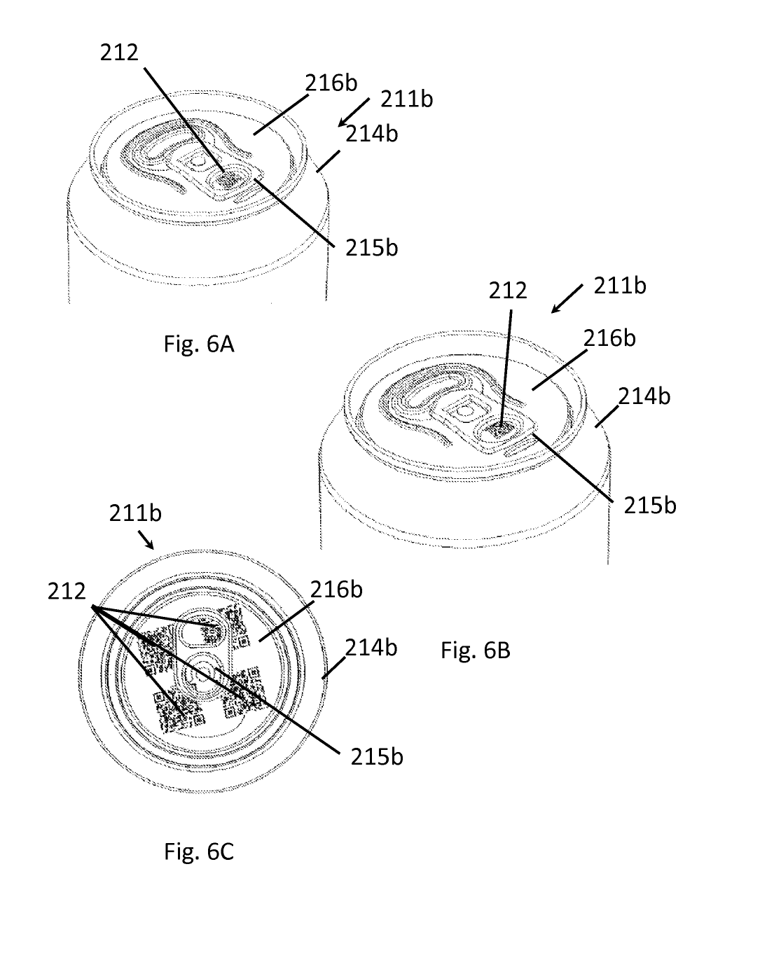

With reference to FIGS. 6A-C, the readable code 212 may be marked a topside of end 216b of a metal beverage container 211b. For example, the readable code 212 may be printed on the topside of end 216b in such a way that it is not hidden or obscured by the tab 215b. Alternatively, the readable code 212 may partially underlie the tab 215b. FIGS. 6A and 6B show readable codes 212 that are positioned on the end 216b underneath an aperture 217b in the tab 215b, so that the entire readable code 212 may be viewed through the aperture 217b. FIG. 6C shows four readable codes 212, such as QR codes that are each at least partially obscured by the tab 215b. The embodiment shown in FIG. 6C is configured such that the readable code 212 may be applied regardless of the rotational orientation of the can end at the times of marking and conversion. By contrast, with the examples of FIGS. 6A and 6B, the readable code 212 should be correctly applied at an alignment corresponding with the intended future position of the tab after the conversion process.

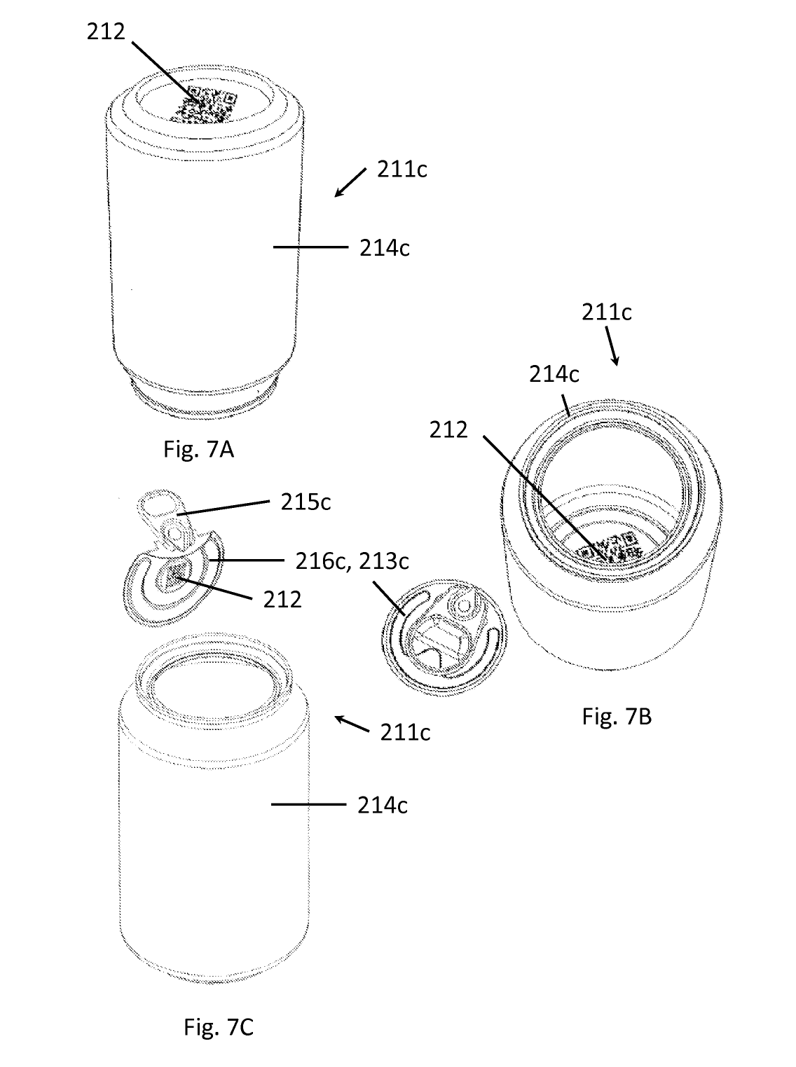

Turning to FIGS. 7A-C, the readable code 212 may alternatively be marked on a full aperture metal beverage container 211c. Like metal beverage container 211b, the full aperture metal beverage container 211c includes a body 214c, an end 216c, and a tab 215c riveted to the end 216c. The full aperture metal beverage container 211c further includes a removable portion 213c that is configured to be separated from the remainder of the end 216c. As shown in FIG. 7A, the readable code 212 may be marked on the underside of the body 214c. Alternatively, as shown in FIG. 7B, the readable code 212 may be marked on an upper surface of the base of the can, such that the readable code 212 is visible after the full aperture metal beverage container 211c has been opened and the product removed. As shown in FIG. 7C, the code may alternatively be marked on the internal underside of the removable portion 213c, such that the readable code 212 is viewable after the removable portion 213c is removed from the end 216c.

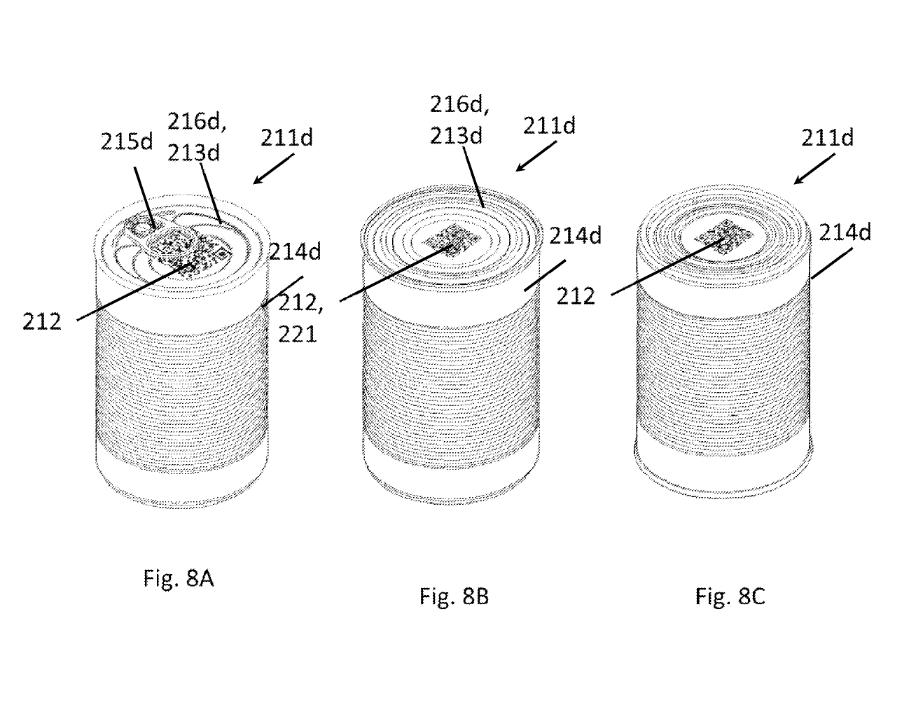

FIGS. 8A-C show various types of food cans 211d with readable code 212 markings. Food cans 211d each include an end 216d seemed to a body 214d. The end 216d includes a removable portion 213d that may be removed from the end to access the product. A tab 215d may be riveted to the end 216d. For example, FIG. 8A is an easy open food can having tab 215d riveted to the end 216d. As shown in FIG. 8A, the readable code 212 may be marked on the end 216d so that it is partially obscured by the tab 215d. FIG. 8B shows a readable code 212 on a non-easy open end 216d. FIG. 8C shows a readable code 212 on the external surface of the base of the body 214d.

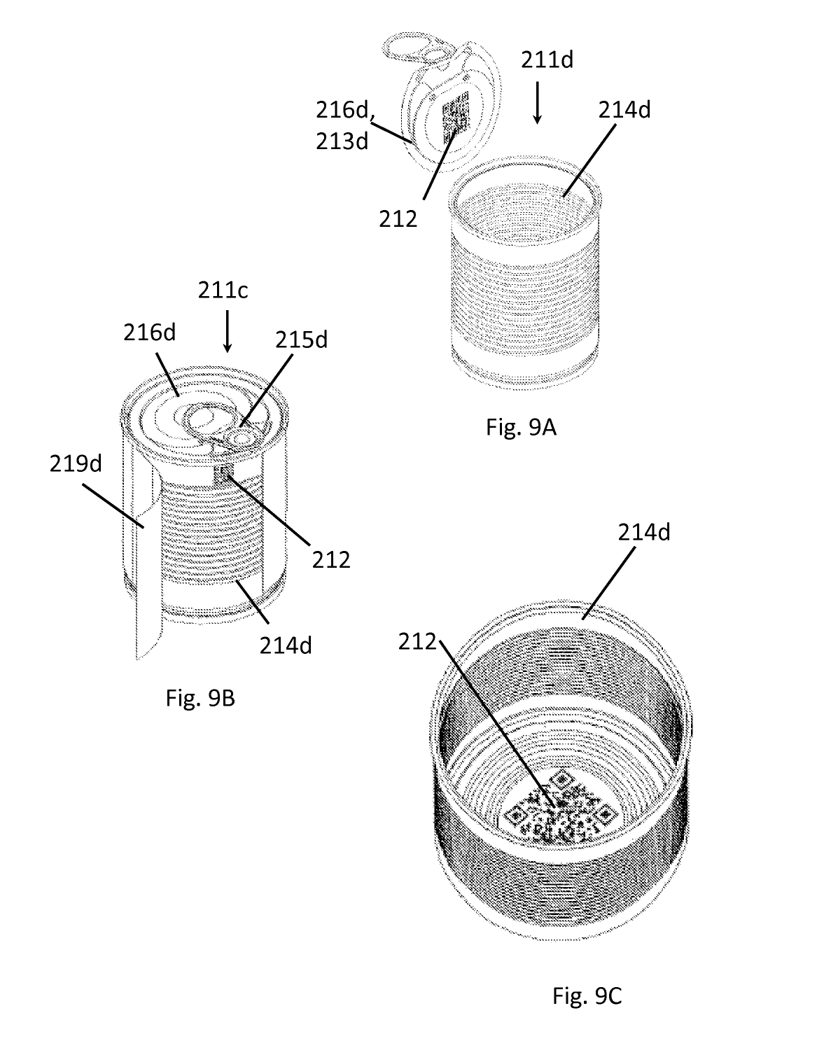

As shown in FIGS. 9A-C, food cans 211d may alternatively have readable codes 212 in other locations. For example, the food can 211d depicted in FIG. 9A has a readable code 212 on the underside of the removable portion 213d so as to be viewable once the removable portion 213d has been separated from the remainder of the end 216d. In FIG. 9D, the readable code 212 is printed on the external surface of the sidewall of the body 214d. A label 219d may at least partially obscure the readable code 212 when the label is attached to the body 214d. FIG. 9C shows the readable code 212 marked on the internal surface of the base of the body 214d, such that the readable code 212 is viewable after the food can 211d has been opened and the product removed.

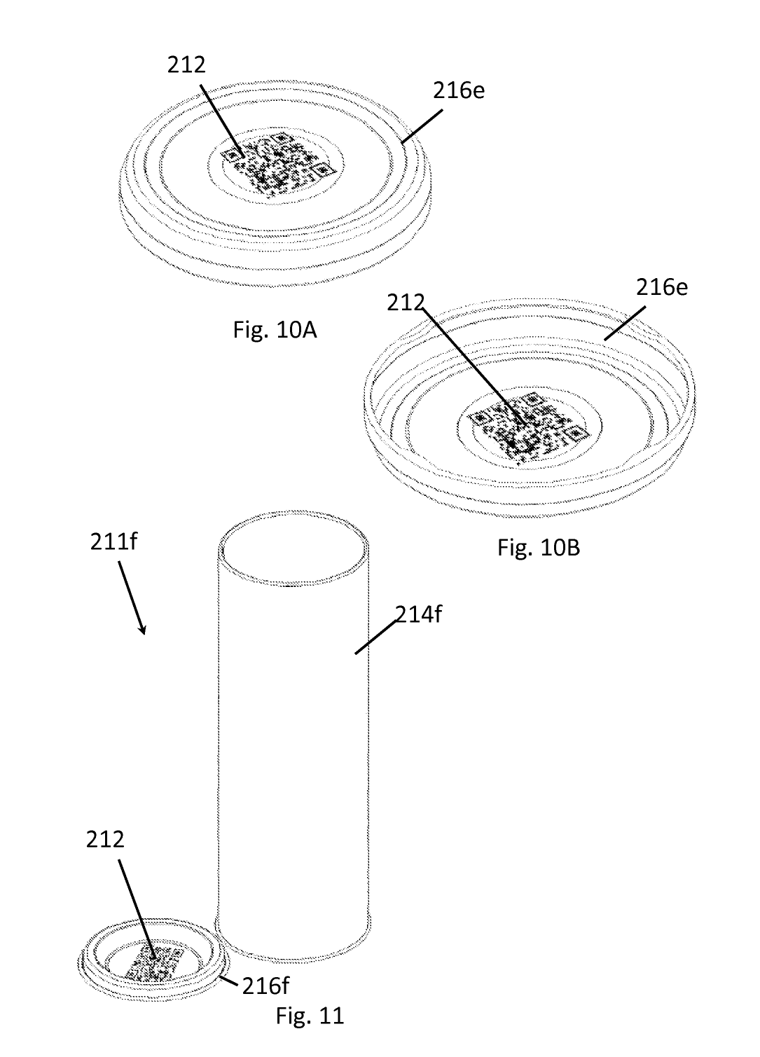

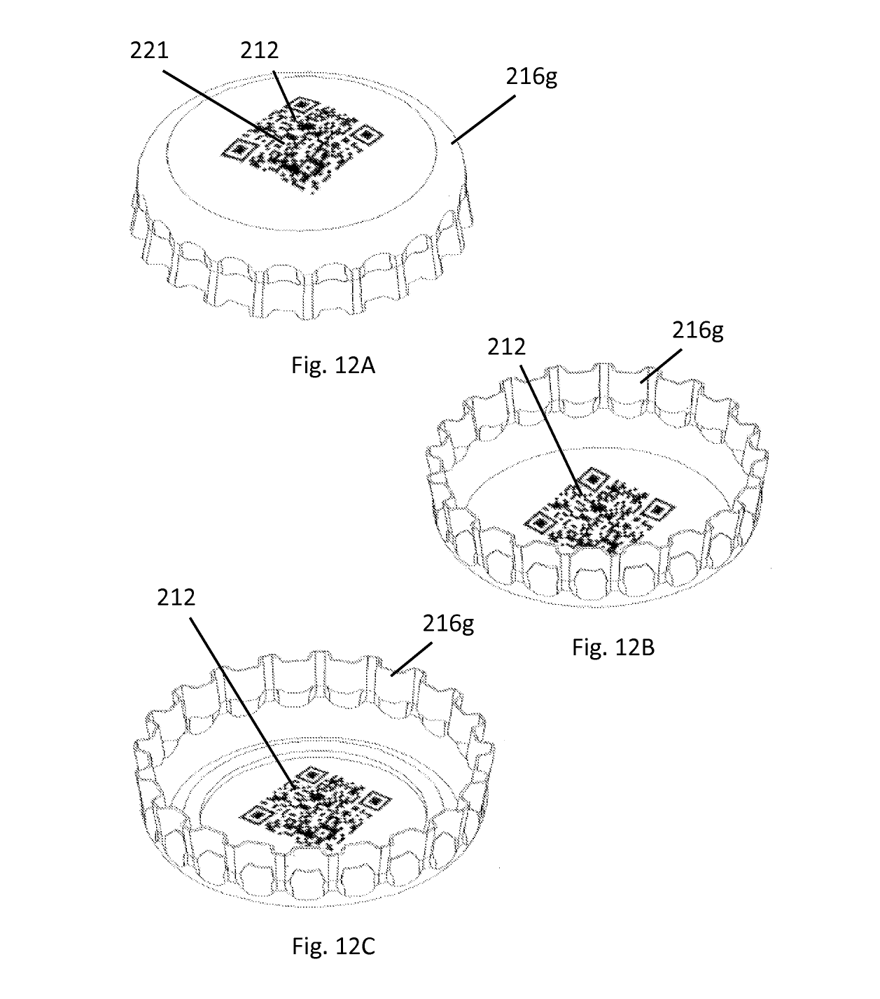

Referring to FIGS. 10A-12C, container 211 may be a non-metal container. For example, as shown in FIGS. 10A and 10B, the readable code 212 may be applied to a metal lid 216e that may be applied to a glass or a plastic body (not shown). The readable code 212 may be applied to the external surface (FIG. 10A) or the internal surface (FIG. 10B) of the metal lid 216e. Alternatively, as shown in FIG. 11, the container 211 may be a tubular cardboard container 211f that includes a cardboard body 214f and two metal end caps 216f. Either or both of the metal end caps 216f may be marked with the readable code 212, such as on the internal surface of the end caps 216f. As shown in FIGS. 12A-C, container 211 may also be a beverage bottle, such as a glass or plastic beverage bottle that includes a glass or plastic body (not shown) and has a crown cap 216g. As shown in FIG. 12A, the readable code 212 may be marked on the external surface of the crown cap 216g. Alternatively, the readable code 212 may be marked on an internal surface of the cap 216g as shown in FIG. 12B. As shown in FIG. 12C, the readable code 212 may also be marked on a liner 209g of the crown cap 216g.

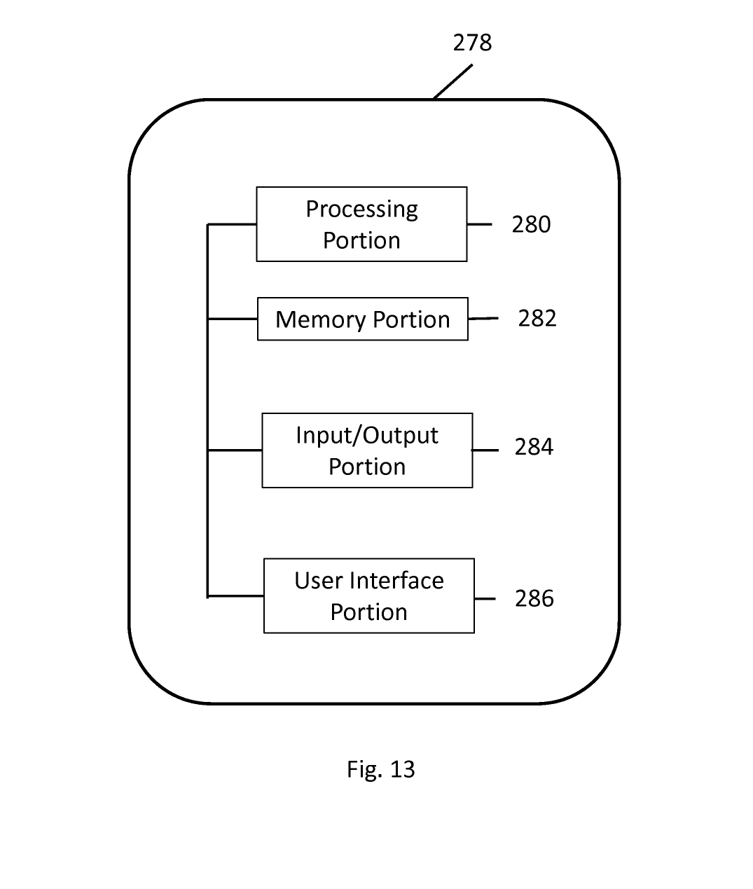

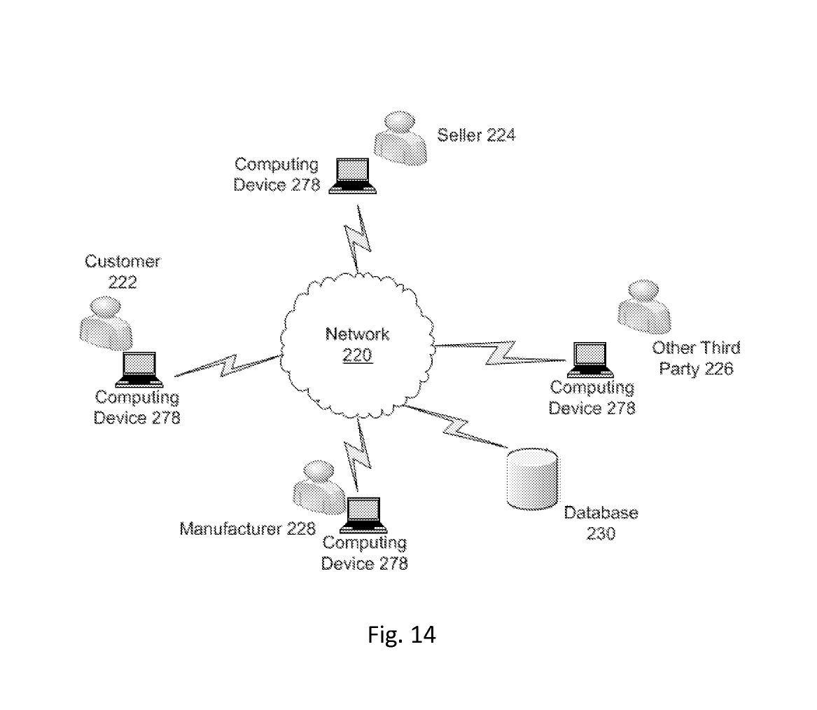

With reference to FIGS. 13 and 14, the computing device 278 used to read the readable code 212 may be a smart phone or like handheld wireless device accessible to consumers and shoppers. The computing device 278 may include a camera, or another feature capable of reading readable code 212. As shown in FIG. 13, any suitable computing device 278 may be configured to host at least part of the system 200 for facilitating interaction between a computing device and a package. It should be understood that the computing device 278 can include any appropriate device, examples of which include a desktop computing device, a server computing device, or a portable computing device, such as a laptop, tablet or smart phone.

In an example configuration, the computing device 278 includes a processing portion 280, a memory portion 282, an input/output portion 284, and a user interface (UI) portion 286. It is emphasized that the block diagram depiction of computing device 278 is exemplary and not intended to imply a specific implementation and/or configuration. The processing portion 280, memory portion 282, input/output portion 284 and user interface portion 286 can be coupled together to allow communications therebetween. Any of the above components may be distributed across one or more separate devices and/or locations.

In various embodiments, the input/output portion 284 includes a receiver of the computing device 278, a transmitter of the computing device 278, or a combination thereof. The input/output portion 284 is capable of receiving and/or providing information pertaining to communicate a network such as, for example, the Internet. Transmit and receive functionality may also be provided by one or more devices external to the computing device 278.

Depending upon the exact configuration and type of processor, the memory portion 282 can be volatile (such as some types of RAM), non-volatile (such as ROM, flash memory, etc.), or a combination thereof. The computing device 278 can include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the computing device 278.

The computing device 278 also can contain the user interface portion 286 allowing a user to communicate with the computing device 278. The user interface 286 can include inputs that provide the ability to control the computing device 278, via, for example, buttons, soft keys, a mouse, voice actuated controls, a touch screen, movement of the computing device 278, etc. The user interface portion 286 can provide outputs, including visual information (e.g., via a display), audio information (e.g., via speaker), mechanically (e.g., via a vibrating mechanism), or a combination thereof. In various configurations, the user interface portion 286 can include a display, a touch screen, a keyboard, a mouse, an accelerometer, a motion detector, a speaker, a microphone, a camera, a tilt sensor, or any combination thereof.

FIG. 14 depicts one example of a suitable communication architecture that may be used in the system 200 for facilitating interaction between a computing device and a package. In addition or instead of the architecture shown in FIG. 14, numerous suitable alternative communication architectures are envisioned. Once the system 200 for facilitating interaction between a computing device and a package has been installed onto the computing device 278 such as described above or possibly another device, it can transfer information between other computing devices 278 on a common network 220, such as the Internet. In an example configuration, a producer 224, such as the producer of the package, may transmit via the network 220 information relating to the display of a personalized illusory image at least one other computing device 278.

The other computing device(s) 278 may be associated with at least one of a customer 222, a manufacturer 228, and a third party 226. The customer 222 may be a person who has purchased the package 210 or may purchase the package 210.

The producer 224 may be the company that produces the product that is enclosed within the container 211 of the package 210. For example, the producer 224 may receive a container 211 in a disassembled state. The producer 224 may enclose the product in the container 211 and send it to a vendor or retailer for sale to the customer 222. In some embodiments, the producer 224 may also mark the readable code 212 on the container 211.

The manufacturer 228 may be the entity that produces the container 211. For example, the manufacturer 228 may form the container 211, such as metal beverage can 211b from sheet metal. The manufacturer may then send the metal beverage can 211b in a disassembled state wherein the body 214b and end 216b are unattached to one another. The manufacturer 228 may also mark the container 211 with the readable code 212. Alternatively, another entity, such as the producer 224 may mark the container 211 with the readable code 212.

The third party 226 may be an entity that otherwise facilitates interaction between a computing device and a package. For example, the third party 226 may be a vendor and/or retailer of the package 210. Alternatively, the third party 226 may be an entity that delivers neutral information regarding the package 210 to customer 222 that is wholly independent from the producer 224, manufacturer 228, or other third party 226. In some embodiments, there are multiple third parties 226. Further, any combination of the producer 224, the manufacturer 228, and the third parties 226 may be part of a single entity. For example, a single company may include the producer 224 and the manufacturer 228. Alternatively, each of the producer 224, the manufacturer 228, and the third parties 226 may be separate entities.

The computing devices 278 and the database 230 depicted in FIG. 14 may be operated in whole or in part by, for example, the producer 224, the manufacturer 228, and the third parties 226, or by any combination of any of the above entities. Further, each of the parties set forth above and/or other relevant parties may operate any number of respective computers and may communicate internally and externally using any number of networks including, for example, wide area networks (WAN's) such as the Internet or local area networks (LAN's). The database 230 may be used, for example, to store information regarding product contained within the container 211 of package 210. The database 230 may also be used, for example, to store information obtained from entities such as the customer 222, the producer 224, the manufacturer 228, and the third parties 226.

Referring again to FIG. 1, a schematic is shown for the method 100 of facilitating interaction between a computing device and a package. In the first step 105, an application, such as a readable code scanning app, is opened on the computing device 278 in order to scan the readable code 212. In one embodiment, a user, such as the customer 222, may have a smart phone or other mobile device with a camera that is configured to work in conjunction with the scanning app to read the readable code 212. In other embodiments the user may be the end user of the package 210, such as a person who receives the package 210 as a gift from the customer 222.

In a second step 110, scanning app reads the readable code 212. In some embodiments, the scanning app may be configured to require that a user take a picture of the readable code 212. Alternative embodiments may be configured to automatically scan a readable code 212.

In a third step 115, the computing device 278 decodes the readable code 212. In a fourth step 120, the computing device 278 opens a URL encoded in the readable code 212. In one embodiment, the fourth step occurs after step 115 results in a signal being sent to a web browser on the device to open the URL.

In other embodiments, the method 100 may also or alternatively include downloading a second application or offering the user the option of downloading a second application. Other embodiments may also or alternatively include automatically opening a video or offering the user the option of viewing a video. When fourth step 120 occurs, the user may access information relevant to interaction between a computing device and a package.

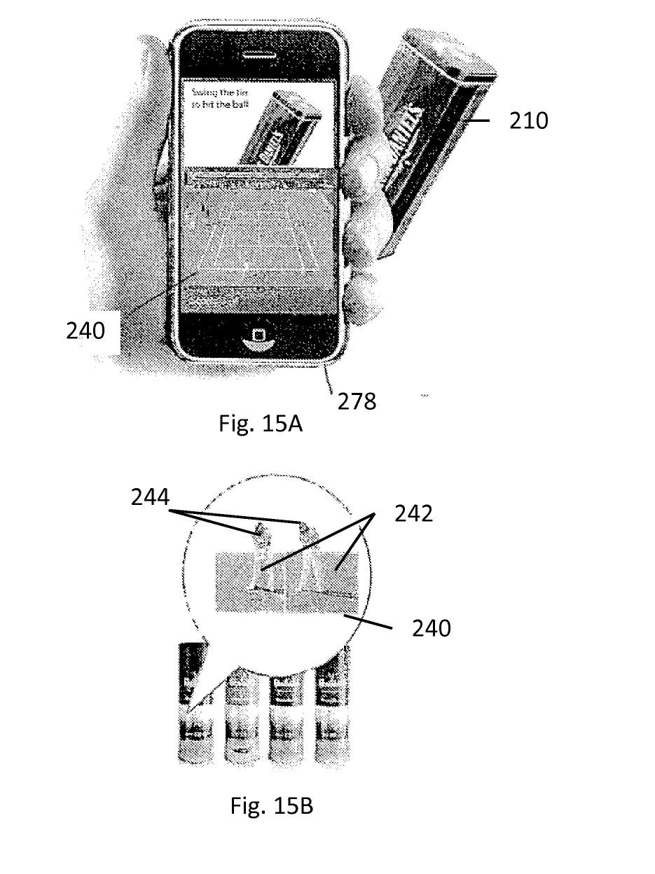

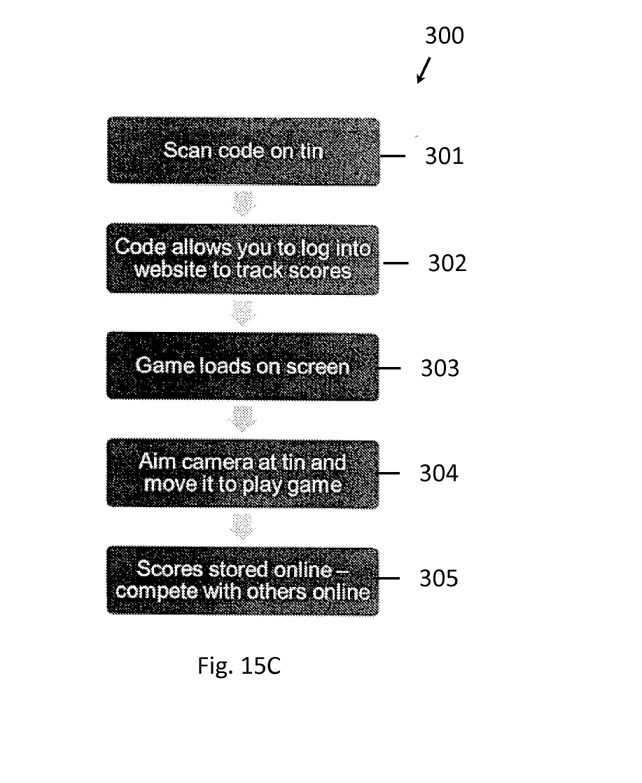

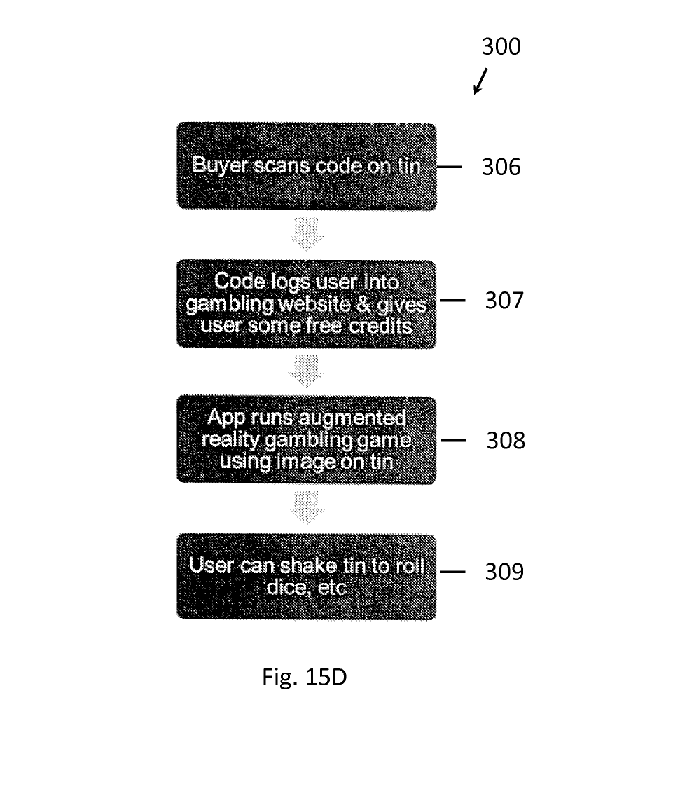

For example, FIGS. 15A-D depict a gaming interaction 300 between a package and a computing device 278. Referring to FIG. 15C to illustrate the gaming interaction 300 that may be facilitated by an application on the computing device 278, computing device 278 may read the readable code 212 on the package 210 at step 301.

Upon reading, at step 302, the computing device 278 loads a website that tracks scores for the gaming interaction 300. At step 303, the computing device 278 displays and renders a game image 240 (shown in FIG. 15A), such as a 2D image, 3D image or video on the user interface portion 286. Game image 240 may be a personalized illusory image. When the game image 240 appears on the computing device 278, at step 304, the user is able to aim a camera of the computing device 278 at the package 210 (as shown in FIG. 15A) to physically move the computing device 278 and package 210 relative to one another to participate in the gaming interaction 300.

Relative movement between computing device 278 and package 210 can move a player or an implement in the gaming interaction 300 so as to, at least in part, determine the outcome of the gaming interaction 300. For example, as shown in FIG. 15B, relative movement between the computing device 278 and the package may alter the game image 240 such that a game implement 242 such as a golf club, appears to move within the game image 240. In alternative embodiments, game implement 242 may be a tennis racket, a baseball bat, a cricket bat, a golf club, a weapon, a human leg, a human arm, or like implements or tools. In addition to the game implement 242, the game image 240 may also alter such that a character 244, such as a famous golf personality, or a portion of the character 244, also appears to move.

At step 305, based at least in part on the relative movement of the computing device 278 and the package 210, scores or a score may be determined for the gaming interaction 300. This score may be stored within the system 200 for facilitating interaction between a computing device and a package. For example, information relating to the score may be sent via the network 220 from the computing device 278 that moves relative to the package 210 to another computing device 278 or the database 230. In this way, multiple users can also compete against one another via the network 220. Further, information from prior gaming interactions 300 may be accessible via the network 220. Embodiments described herein may encompass gaming interactions 300 with other users in real time, such that a user may compete against other players and/or against a machine. Purchasing additional packages 210 may provide enhanced playing capabilities or game implements 242. For example, purchasing additional packages 210 may provide a tennis game with greater speed or hitting power, or a better racket.

Referring now to FIG. 15D, gaming interaction 300 may be an interactive gambling game. Step 306 includes scanning the readable code 212, which enables the user to access information (either stored on computing device 278 or on a database 230 accessible through the network 220) regarding credits available for gambling at step 307. The magnitude of credits may be controlled by information in the readable code 212. At step 308, game images 240 can be displayed on user interface portion 286 to represent game implements 242, such as dice rolling, roulette wheel, a slot machine, or cards. At step 309, relative movement between computing device 278 and package 210 by the user controls the interactive gambling game. For example, movement of package 210 may be represented on user interface portion 286 as shaking and rolling dice.

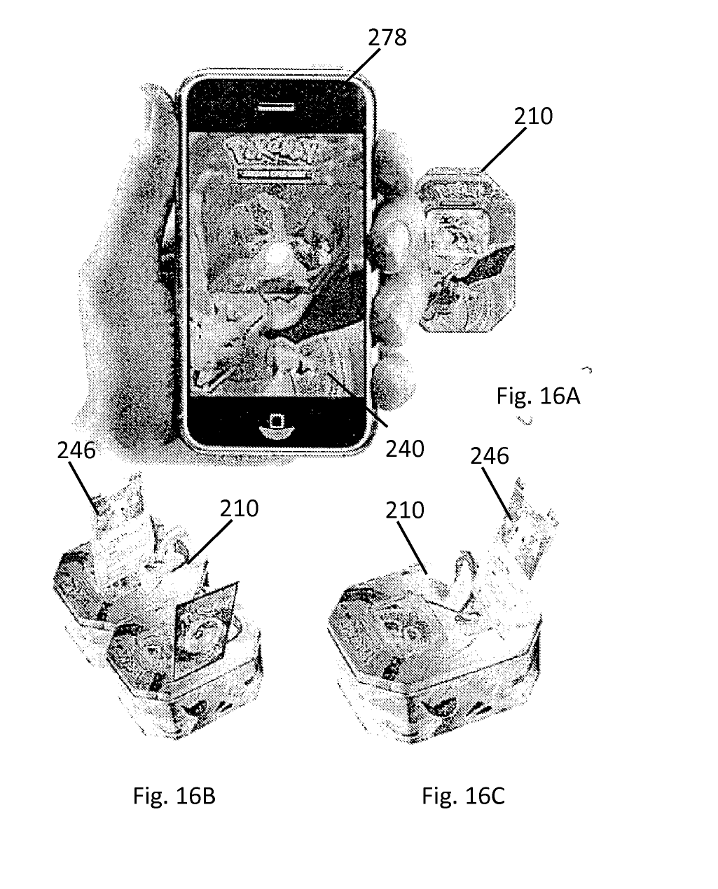

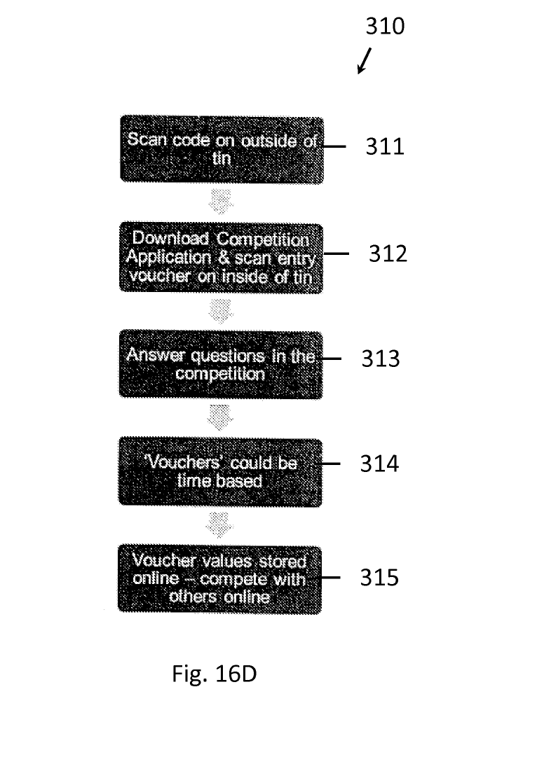

The method 100 and system 200 for interaction between a computing device and a package may also provide for promotional interaction 310 that may be facilitated by an application on the computing device 278. For example, the promotional interaction 310, such as the promotional interaction 310 shown in FIGS. 16A-D, may include an registering credits based on voucher information. Promotional interaction 310 may include scanning readable code 212 at step 311. A first readable code 212 may be on an exterior of package 210. At step 312, a second readable code 212 may be scanned after purchase. For example, the readable code may be at least partly beneath an overwrap of the package 210 or on an interior surface of the package 210 so as to be accessible after purchase. In some embodiments, the package 210 may further include decoration of a game image that relates to the gaming interaction. For example, the package 210 may have a screen surface, such as a card 246 (shown in FIGS. 16B and 16C). The promotional interaction 310 may be configured such that a computing device 278 incorporates the voucher information for the new purchase (that is, the purchase of package 210) with pre-existing voucher information, if any.

At step 313, the promotional interaction 310 may run a competition that the user plays to determine the value of the voucher. For example, the competition application may be a trivia game relating to the product 210 that appears as a game image 240 on the computing device 278. As indicated at step 314, the answers to the questions in step 313 may be time based. The results of the competition application may be displayed or tabulated against those of other players for ranking or like purposes. The voucher values may be stored via the network 220 at step 315. The current location of the computing device 278 may be determined, such as by the GPS of computing device 278 to link the voucher to offers from third parties 226, such as local vendors and/or retailers.

According to another embodiment of the promotional interaction 310, the readable code 212 may link to information stored on computing device 278 or a remote server for playing an interactive game 300, such as the interactive games 300 described above. Purchases, represented by readable codes 212 may provide characters 244 or the capabilities of the characters, such as shown in FIG. 15B. User interface portion 286 may provide a representation of the game image 240 upon pointing a camera at a screen, such as the card 246 associated with the game or a surface on a portion package 210. For example, cards 246 (which may be contained with or as the product in package 210) may include an image of a character 244, and the game application recognizes the character 244 such that the game enables animation of the character 244 according to commands in the game and controlled by the user. The game may be controlled by relative movement between computing device 278 and the screen, or by virtual or physical buttons on computing device 278.

In another exemplary embodiment of the promotional interaction 310, crown caps 515, such as those shown in FIGS. 12A-C may be used. Crown caps, such as crown caps 515 are typically printed in sheets with approximately 621 crowns on each sheet. The sheets may be printed using conventional printing techniques (high-definition printing using print rollers), prior to stamping out the crowns. By printing a limited number of the crown caps on each sheet with codes which correspond to a unique predetermined outcome, a limited number of the crowns in each sheet may be printed with codes that link to winning prizes, while the remaining crowns on the sheet do not provide any reward, provide a reward of lower value, or otherwise simply link to an associated website, for example. Alternatively, the winning crown caps may each be marked with unique identifiers, using any of the aforementioned techniques.

Another similar use for such crowns and other metal components of packages is for the unique identifiers to link to collectable tokens or vouchers. One way in which this may be applied is to link the different codes to players in a sports league, whereby, by collecting the codes from containers 211, such as the crown caps 216g, the consumer can build up a virtual sports team, or collect all of the players from the given league via the network. The collection may then be stored in electronic form via the network 220, or on the user's computing device 278. Remote access may be provided to the user via the network, for example by logging into a personal account.

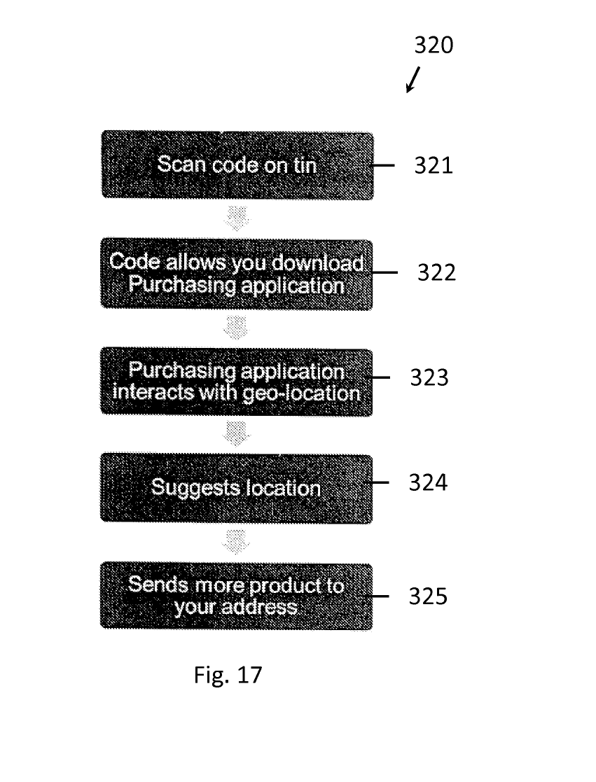

Referring to FIG. 17 to illustrate a repurchase interaction 320 that may be facilitated by an application on the computing device 278, a user may scan readable code 212 at step 321 and, at steps 322 and 323, the computing device 278 may facilitate determining the current location of the computing device 278, preferably by employing the GPS feature of computing device 278. At step 324, the computing device 278 may display repurchase information, such as information on the availability of optional products within geographic area and offers for additional products. The relevant geographic area may be determined by a pre-determined factor, or may be determined by a pre-determined variable, such as radius from the current location. In this regard, a user may choose a value for the variable, such as the mile value for the radius. Also, as shown at step 325, the computing device may be configured to send more product to the user's home or business address.

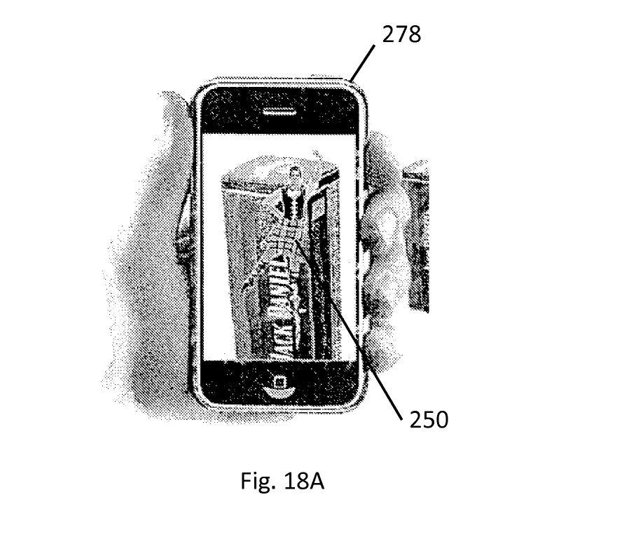

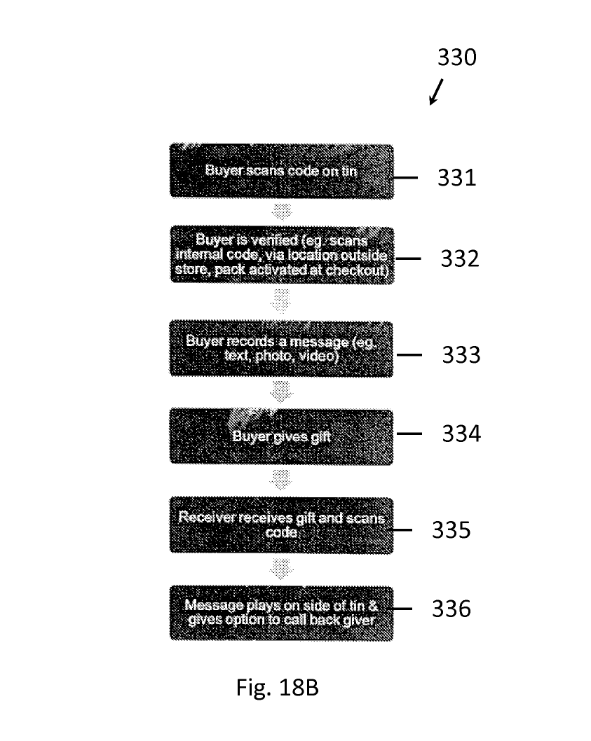

Referring to FIGS. 18A and 18B, a gift message interaction 330 that may be facilitated by an application on the computing device 278 includes scanning readable code 212 that enables playing a pre-inputted message 250 (such as a video, audio, and or graphical or textual message) that has been provided, such as by upload to the database 230 via the network 220, by a gift giver, such as the customer 222. Thus, upon receiving a gift of package 210, a recipient upon opening the package, which broadly encompasses opening lid, such as lid 216a or an overwrap to expose readable code 212, may view the message from the recipient. Preferably, user interface portion 286 plays the message as if the message appears on a portion of the package or otherwise employs the package as background, a stage, or like backdrop.

The readable code 212 may be activated upon purchase by the gift recipient. For example, the merchant may activate or enable the identifier in such a way so the identifier and package are linked to the message. A method associated with gift message interaction 330 is outlined in FIG. 18B outlines the steps associated with this process. At step 331, the customer 222 scans a readable code 212 on the package 210. At step 332, the customer's purchase is verified. The customer 222 may then record a message 250 via a computing device 278 at step 333. This message 250 is then uploaded via the network 220 and stored on the database 230. The customer then gives the package 210 in the form of a gift at step 334. The recipient then uses a computing device 278 to scan the readable code 212 at step 335 and the message 250 appears at step 336.

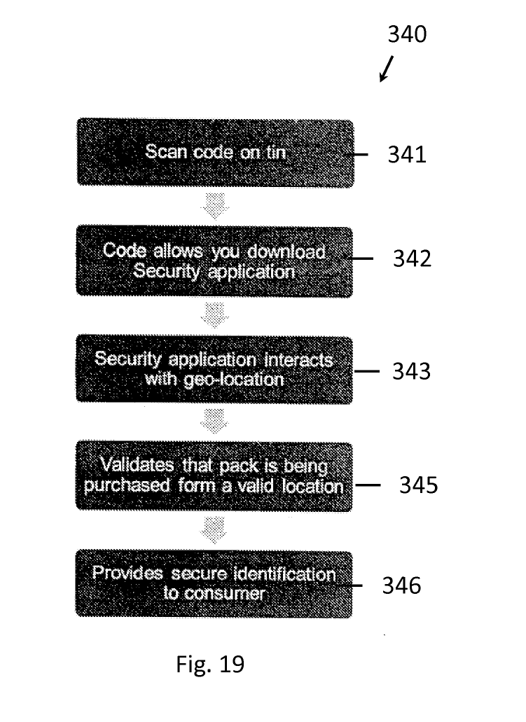

Referring to FIG. 19, a validating interaction 340 may be facilitated by an application on the computing device 278 application includes scanning readable code 212 at step 341, which may be accessed before the package 210 is purchased. For example, readable code 212 may be on the outside of package 210 such that is accessible before opening. In some embodiments, a user may initiate the validation interaction 340, by scanning the readable code 212, using a computing device 278 such as a kiosk locates in or near a vendor and/or retailer.

After step 341, at step 342, the application may be downloaded via the network 220 to the computing device 278. In cooperation with a GPS on the computing device 278, the location of the computing device 278 (and, therefore, the package 210) may be determined. At step 345, the location of the package may be compared to known locations of authorized sellers (e.g., vendors and/or retailers). For example, the database 230 may contain a list of addresses of authorized retailers of a given product. At step 346, information regarding the authenticity of the product may be displayed.

In alternative embodiment, determining the authenticity of package 210 or its product may be achieved by scanning the shape or decoration of the product or its package and assessing the shape or decoration of the product or package, such as comparing the image of the shape or decoration against an image or data on computing device 278 or the database 230. Scanning may include scanning the resolution or quality of the decoration of package 210 to confirm that the decoration corresponds to factory decoration resolution or quality, which may be especially employed to police poor quality, unauthorized packages. Alternatively or in addition, the scanning step may include checking for a covert image watermark, as will be understood by persons familiar with such watermarks for packaging.

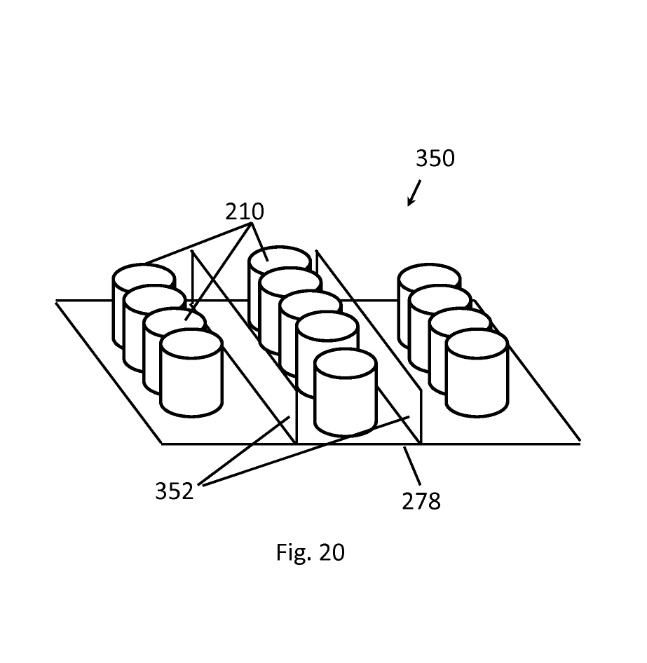

Referring to FIG. 20, where a marking is applied to the outer surface of the container 211, in a location where the marking can be read prior to opening of the package, the package 210 may be scanned automatically by various computing devices 278 such as code scanners as part of a stocking system 350. For example, where a readable code 212 is printed on the external underside of the base of a can, the stocking location where the can is kept in stock, such as on a supermarket shelf, may be provided with a computing device 278 that may include cameras, for identifying the packages 210, and additional related information, such as “Best Before” or “Use By” dates. The shelf unit may be configured to display related information, such as an appropriate indication of the price for the packaged product.

In conjunction with the network 220, the stocking system 350 may also be used to facilitate stock control, where the shelf unit or other stocking location is equipped with computing devices 278 and a control system able to identify the number of such packages 210, as well as the shelf life of those products. For example, a shelf may be provided with a number of separate cameras configured to read the readable codes 212 of the packages 210 from a number of different angles. Alternatively, the shelf may be configured with an upper surface which has in it computing device 278 configured to read readable codes 212 printed or otherwise marked on the bottom surface of the package 210. The shelf unit may also be provided with dividers 352 or similar structure configured to facilitate the positioning of packages 210 on the shelf, whereby the package 210 may be positioned in a location where the readable code 212 can reliably be read.

Similar to the stocking system 350, other systems may employ various smart working surfaces, having code readers built therein, capable of reading the readable code 212 or other marking on the base of a packaged product. These devices might include, for example, a kitchen work surface or the surface a bar or a table, such that placing the packaged produce on the surface will cause to be displayed related information, or allow access to associated information or related content. For example, on a smart kitchen worktop, the placement on top of the smart worktop of a packaged product having a readable code 212 on the underside of the base, so as to be read by the smart surface, may allow the user to access various information, such as nutritional information, information regarding the product manufacturer or producer, or related information such as reward content. Such information may then be displayed on the smart worktop or on an associated display device. Alternatively, the system may provide for multi-media playback of associated content, for example video or music.

As well as being used for interaction with the customer 222, the readable codes 212 described herein can be used to assess environmental conditions experienced by the product. For example, a marking on the container may be configured to change in accordance with environmental conditions such as temperature range, time-temperature condition, and light of a particular wave length. In this way, the readable codes 212 may be used to display quality information about the product in the container 211. These changes may be permanent or temporary or both. The marking may be configured to display a readable code 212 without experiencing any given environmental conditions. Alternatively, the marking may not display the readable code 212 until at least one environmental condition has occurred.

In some embodiments, changeable markings may be used during the production of the package 210. For example, ink that includes time-temperature components can facilitate the producer 224 or the manufacturer 228 to identify whether a product has been properly processed during manufacture. Specific examples include the pasteurization of milk-based products, and similar items such as beer and food, which have to be heated in order to kill off bacteria and increase the shelf life or the product enclosed in the container 211, after the product, such as a food or beverage, has been sealed in the container 211. For example, the package 210 may be heated above a threshold temperature for a predetermined minimum period of time such that portions of the marking 221 (shown in FIG. 8B) on the container 211 change to display a given readable code 212.

By creating a marking 221 on the container 211 that is configured to display a readable code 212 that at least partially comprises a suitable time-temperature dependent material, the producer 224 or product manufacturer will be able to ascertain from the readable code 212 (or lack thereof) whether or not the package 210 has been correctly processed. For example, the readable code 212 may only become visible when a predetermined time-temperature condition has been met which corresponds to correct processing of the particular food or beverage to be contained in that package 210. The readable code 212 may be a machine-readable code, and may provide information regarding the temperature and/or humidity at which the package 210 is to be kept. Alternatively, in an automated storage device provided with temperature control, a readable code 212 may be used to indicate whether the package 210 is at the desired temperature, or whether the temperature at which it is being stored needs to be increased or lowered.

The producer 224 of the package 210, as mentioned above, may also wish to provide markings 221 on the package 210 that relate to a date on which a particular product batch was made and also a “Sell By” or “Use By” date, which may determine the shelf life of the package 210. A marking 221 may be provided on the container 211 that includes ink that changes over time, so as to display a readable code 212 after the “Sell By” or “Use By” date than the readable code 212 that appears before that date.

A similar application relates to the automated vending of such products, or the preparation of such products for sale. In an automated vending machine, a thermochromic marking 221 may be used to indicate to the machine whether the product is at an appropriate temperature or being dispensed. For example, a beverage can (for: example, containing beer) may be marked with a thermochromic ink which will only reveal a predetermined readable code 212 when the can is sufficiently cold, according to the beverage manufacturer's requirements. The vending machine may then be configured only to dispense the can to a consumer when the code is readable, thus indicating that the product is at the desired temperature or within the desired temperature range. Alternatively, where food preparation is involved, a thermochromic marking 221 may be used to indicate whether a package 210 has been sufficiency heated in order to serve to a customer 222.

Similarly, certain types of packages 210, such as beer bottles, may include a marking 221 that changes into a readable code 212 when exposed to light of a particular wavelength. For example, a crown cap 216g may have a marking 221 (shown in FIG. 12A), that when exposed to light of a particular wavelength displays a readable code 212 that may be used to indicate that the beer (i.e., the product) contained in the bottle may have spoiled.

The above aspects encompass steps and systems that may be used to perform the particular function, as will be understood by persons familiar with wireless communication devices such as smart phones and tablet computers. For example, downloading applications may occur upon initially scanning a code, as described above, may be a pre-condition to performing any on the above steps, may be performed from the computing device 278 itself or via the network 220 that is connected to a computing device 278, and the like. Further, some embodiments may encompass a system for performing the steps described herein, as will be understood by persons familiar with wireless communication devices, such as smart phone and tablet computer technology.

In addition to the exemplary methods of using readable codes 212 described above, exemplary methods of applying readable codes 212 to containers 211 are also contemplated. Specifically, the following exemplary methods provide ways for forming readable codes 212 that may uniquely identify a particular package 210 or container 211 as distinct from other packages 210 or containers 211.

One such technique is to use a laser etching process, in order to mark the readable code 212 onto the package 210. The laser etching process may serve to gradually remove a thin layer of metal from the desired area of a metal portion of a container 211, thereby directly etching the metal surface. In a similar process, it is also possible to apply two or more layers of lacquer, ink, or other pigmented substance to the surface of the container 211, and then to ablate the uppermost layer or layers from the surface of the container 211, so as to reveal an underlying layer of lacquer, ink, or other pigmented substance. In this way, an upper layer of the lacquer is ablated from the surface of the metal package or metal component of a package, to reveal another underlying layer, without etching the metal itself.

A further technique which may be used is to apply a layer of a photonically active material to the surface of the metal package or metal component, and then to irradiate the photonically active component with light of a specific wavelength, in order to activate the photonically active component. Activation of the photonically active component brings about a change in the color, darkness or opacity of the photonically active component or an associated pigment, or may render a transparent portion of the layer opaque, or vice versa, so as to produce a pattern on the container 211 corresponding to the irradiation pattern applied to it. A laser may be used for irradiating the photonically active layer, or such irradiation may be done with a filtered light source in order to provide sufficiently bright light at the desired wavelength.

It is also possible to provide marking on a container 211 using an ink jet printer. The use of ink jet printers activates the application of many different types of ink to the surface of the container 211. One example would simply be to print dark ink onto a plain or transparent lacquered metal surface. However, the ink jet printing process may also be used to print different types of ink onto the surface of the container 211, each of which provides for several different uses. One option is to print a transparent marking, in the form of a code or otherwise, onto the surface of container 211, using a fluorescent ink. Such an ink will be substantially invisible to the human eye, or indistinguishable from other decoration applied to the package, when applied to the container 211, but will be revealed when irradiated with an appropriate light source. One example of such inks are those which respond to ultraviolet light, as used on bank notes and similar watermark applications.

In addition to inks which may become visible to the human eye when irradiated with an appropriate light source, inks which are substantially invisible to the human eye, but which are machine readable, either with or without requiring irradiation by an exciting light source may be employed. As used herein, the term visible means visible to the human eye in daylight, without magnification or other visual aid (excepting personal vision-correcting eyewear). In some cases, it may be that the human eye can discern on close inspection that an invisible ink or a similar marking has been applied to a surface, for example if the marking is thick enough to stand out on the surface, or if it is not fully transparent or partially distorts the underlying decoration. Such markings are still considered as being invisible, the intention being that they go unnoticed to casual observer. For some inks, even on closer inspection of such markings, it may not be possible to make out the code or marking as a whole, without visual aid.

A further type of ink which may be used is a thermochromic ink, which will change color according to the temperature of the ink. For example, certain inks are blue at room temperature, but turn white when cooled to, for example, 4° C. Other such inks may be transparent at room temperature, but will become colored and/or opaque when the temperature is raised or lowered, such that a pattern printed with the ink will only be revealed when the metal package or metal component of a package printed with that ink is brought above or below a particular temperature threshold. (Equally, such inks may be colored and/or opaque at room temperature, but will become substantially transparent when the temperature is raised or lowered, such that an inverted pattern printed adjacent or behind the thermochromic ink will be revealed when the container 211 printed with that ink is brought above or below a particular temperature threshold.)

Similarly, in the same way, time-temperature dependent inks may be used. Time-temperature dependent inks can change color or change between being opaque or transparent, once a particular time-temperature condition has been met, for example where a temperature has been sustained above or below a given threshold for a minimum period of time.

Furthermore, photonically activated inks may be used. Photonically activated inks change color or transparency when irradiated by light at a certain wavelength. If a code or pattern is printed with such inks, it may remain invisible or substantially indistinguishable from other decoration provided to the metal package or metal component of a package, until activated by light of a particular wavelength. A photonically active component or ink may be one which undergoes a chemical reaction when activated, such that the activation process is normally irreversible, once the photonically active ink has been activated.

All of the foregoing techniques may be used to apply markings to metal packages and metal components of packages, and are capable of marking the containers 211 at sufficiently high speed in order to provide a readable code 212 in the form of a unique identifier, if desired, to each of the containers 211 produced by a high-volume mass production process. For example, in the case of metal beverage containers 211b, in a factory producing billions of cans each year, these techniques may be used to provide unique identifiers and other such marks, to each of the cans at the point of manufacture.

Alternatively, the markings need not be applied to the container 211 at the point of manufacture 228 of the container 211, but may be applied before or after a product has been filed or otherwise introduced into the container 211 and/or the container has been sealed. In this case, the package 210 may be marked by the producer 224 of the package 210 prior to or after introducing their product into the package, rather than by the manufacturer 228 of the container 211 (the producer 224 or package manufacturer typically being separate entities).

In order to facilitate the marking of the packaged product by the manufacturer of the product being packaged, a region on the container 211 which can readily be marked may be provided. One way in which this may be achieved is to provide one or more layers of a lacquer, ink or other pigmented, colored or colorable material onto a predetermined area or region of the metal package or metal component. The produce manufacturer may then irradiate the predetermined area or region with an appropriate light source, using one or more of the techniques identified above, in order to apply the desired code or other marking to the predetermined region. As regards printing using a traditional dark-colored ink against a light-colored background provided in said predetermined region on container 211, typically such inks do not adhere well to an already lacquered surface of the container 211, and it may be necessary to print the desired marking at a large size in order to overcome loss of resolution due to the high-speed of such a printing process in a typical production facility. In such cases, traditional inkjet printing using dark-colored ink may not be suitable for marking the container 211 on or immediately adjacent to decorated areas of the package. However, the use of more specialist inks, such as those inks which are initially invisible and which become revealed only upon being illuminated with light of a predetermined wavelength (i.e., fluorescent inks), as well as those which become revealed once a predetermined environmental condition has been realized (thermochromic inks or time temperature dependent inks) may be applied at a larger size to the container 211, and, where these are initially invisible after application to the container 211, they will not distort or obscure the underlying decoration or branding if applied over decorated portions of the container 211.

It is also possible for the producer 224 or the manufacturer of the package 210 to mark the metal package or metal component using laser etching, or to apply an appropriate ink to an un-lacquered bare-metal surface of the metal package or metal component.

The descriptions of the present application may be practiced, by way of example or illustration and not by way of limitation. Embodiments may be combined, other examples or embodiments may be utilized, or structural, logical and mechanical changes may be made without departing from the scope and spirit of the claimed features of the present application. The description is, therefore, not to be taken in a limiting sense. The above description is intended to be illustrative, and not restrictive. As such, the above embodiments and aspects thereof may be used in combination with each other. Other embodiments will be apparent to those skilled in the art after reading the above description. While the foregoing written description of the present application enables one of ordinary skill to make and use the claimed features of the present application, those of ordinary skill will understand and appreciate the existence of variations, permutations, combinations, equivalent means, and equivalents of the specific embodiments, methods, and examples herein. The present application should therefore not be limited by the above described embodiments, methods, and examples, but by all embodiments and methods within the scope and spirit of the present application as claimed.

What is claimed:

1. A method of providing a personalized experience on a wireless communication device corresponding to the contents of a package, the package containing a product, the method comprising the steps of:
reading a unique code on a package, the package containing a product;
displaying a personalized illusory image on the wireless communication device; and
altering the personalized illusory images in response to relative movement between the package and the camera.

2. A method of having a gaming interaction between a package and a wireless communication device, the package having a unique code, the method comprising the steps of:
reading the unique code;
in response to the reading step, displaying game images; and
modifying the game images in response to physical movement of the package relative to the wireless communication device, the physical movement determining an outcome of the gaming interaction.

3. The method of claim 2, wherein the step of displaying game images includes displaying game images corresponding to an interactive gambling game and the step of modifying the game images includes modifying the game images to display at least one of rolling dice, a ball rolling about a roulette wheel, a turning slot machine wheel, and playing cards.

4. The method of claim 2, wherein the step of modifying the game images includes modifying the game images to display swinging a game implement, the game implement being one of a stick, a tennis racket, a baseball bat, a cricket bat, a golf club, a human leg, a human arm, and a weapon.

5. The method of claim 2, wherein the step of modifying the game images includes animating an image of a character.

6. The gaming method of claim 2 further comprising a step of receiving information from remote users of the game, whereby the game is a multiplayer game.

7. A system configured to facilitate a gaming interaction using a wireless communication device comprising:
a package, the package including a unique code; and
an application configured to run on the wireless communication device in response to the wireless communication device reading the unique code, the application further being configured to:
display game images; and
modify the game images in response to physical movement of the package relative to the wireless communication device, the physical movement determining an outcome of the gaming interaction.

8. A method for registering credits based on voucher information on a wireless communication device comprising the steps of:
reading a unique code, the code being marked on a package; and
in response to the reading step, incorporating the new purchase voucher information to pre-existing voucher information.

9. The method of claim 8 wherein the package includes a screen surface, the method further including displaying the game images on the screen surface.

10. The gaming method of claim 8 wherein the screen surface is a card.

11. The method of claim 10, wherein the pre-existing voucher information is stored on the wireless communication device.

12. The method of claim 10, wherein the reading step is performed only after the package has been opened.

13. The method of claim 10, further including displaying an image corresponding to an interactive game that determines the value of the new purchase voucher information.

14. The method of claim 13, further comprising the step of comparing a first user's results of the interactive game with results of a second user's results.

15. The method of claim 14, further comprising ranking at least the first user and the second user based on the comparing step.

16. The method of claim 15, further comprising a step of determining the value of vouchers based on the comparing step.

17. A system configured to register credits based on voucher information on a wireless communication device comprising:
a package, the package including a unique code; and
an application configured to run on the wireless communication device in response to the wireless communication device reading the unique code, the application further being configured to incorporate the new purchase voucher information with pre-existing voucher information.

18. A method of displaying repurchase options on a wireless communication device, comprising the steps of:
reading a unique code, the unique code being on a package that contains a product;
identifying a geographic location of the wireless communication device using GPS; and
displaying information about repurchase options of the product that corresponds to the geographic location.

19. The method of claim 18, wherein the step of displaying information includes displaying information on availability of optional products within a predetermined distance of the geographic location.

20. The method of claim 18, wherein the step of displaying information includes displaying information on additional product offers and/or availability information is provided.

21. A system configured to display repurchase options on a wireless communication device, comprising:
a package, the package including a unique code; and
an application configured to run on the wireless communication device in response to the wireless communication device reading the unique code, the application further being configured to:
read a unique code, the unique code being on a package that contains a product;
identify a geographic location of the wireless communication device using GPS; and
display information about repurchase options of the product that corresponds to the geographic location.

21. A method of receiving a gift message associated with a package having a unique code on a wireless communication device, the method comprising the steps of:
reading the unique code; and
displaying an image that corresponds to the gift message, the gift message being a pre-inputted message provided by a gift giver.

22. The method of claim 21, wherein the code is accessible for scanning only after removal or opening of at least one part of the package.

23. The method of claim 23, wherein the pre-inputted message is recorded at the time of purchase by the gift giver.

24. A system configured to display a gift message on a wireless communication device, comprising:
a package, the package including a unique code; and
an application configured to run on the wireless communication device in response to the wireless communication device reading the unique code, the application further being configured to:
identify a geographic location of the wireless communication device using GPS; and
displaying information about repurchase options of the product.

25. A method of validating a product's authenticity using a wireless communication device, the method comprising the steps of:
reading a unique code on a package that contains the product;
in response to the reading step, identifying a geographic location of the wireless communication device using GPS;
comparing the geographic location with a list of authorized sellers of the product; and
determining the authenticity of the product based on the comparing step.

26. The method of claim 25 further comprising a step of determining the shape or decoration of the product or the container, wherein, the step of determining the authenticity includes assessing the shape or decoration of the product or the package for authenticity.

27. A system configured to validate a product's authenticity using a wireless communication device comprising:
a package, the package including a unique code; and
an application configured to run on the wireless communication device in response to the wireless communication device reading the unique code, the application further being configured to:
identify a geographic location of the wireless communication device using GPS;
compare the geographic location with a list of authorized sellers of the product; and
determine the authenticity of the product based on the comparing step.

28. A package configured to provide quality information comprising:
a container, the container including a changeable marking that is configured to display a unique code in response to at least one environmental condition of the container; and
a product enclosed within the container,
wherein the change in response to the at least one environmental condition reflects a change to the at least one environmental condition of the product, and the at least one environmental condition includes at least one of a temperature range, a time-temperature condition, and light of a particular wavelength.

29. The package of claim 28, wherein the marking is formed by at least one layer that changes its form in response to the at least one environmental condition to display the unique code.

30. The package of claim 29, wherein the at least one layer that changes its form temporarily.

31. The package of claim 29, wherein the at least one layer that changes its form permanently.

32. The package of claim 28, wherein the marking is configured to be substantially invisible to a human viewer and also machine readable.

33. The package of claim 28, wherein the marking is readable by a wireless communication device independent from the orientation of the package.

34. A stocking system configured to manage stock comprising:
a shelf; and
a smart surface disposed on the shelf, the smart surface configured to read unique codes on packages and to transfer and receive information about the packages so as to facilitate:
determining remaining shelf life of the packages;
determining need for restocking of shelf; and
alerting of a potential issue relating to the packages.

35. A method of manufacturing a packaged product comprising:
introducing a product into a package, the package including a marking;
closing the package;
processing the package according to a predetermined process, wherein the processing step changes the marking to display a unique code so as to indicate whether a predetermined time-temperature condition was satisfied during the processing step; and
determining whether the predetermined time-temperature condition was satisfied during the processing step.

36. A method of manufacturing a container, the method comprising the steps of:
forming the container; and
marking the container with a unique code.

37. The method of claim 36, wherein the container is a metal container with a coating and the marking step includes ablating the coating.

38. The method of claim 36, wherein the container is a metal container with a coating and the marking step includes etching the coating.

39. The method of claim 36, wherein the container is a metal container with a coating and the marking step includes activating an energy responsive element in the coating.

40. A method of manufacturing a container comprising the steps of:
positioning the container;
filling the container with a product; and
marking the container with a unique code.
